(19) United States
(12) Patent Application Publication
(10) Pub. No.: US 2025/0232617 A1
(43) Pub. Date: Jul. 17, 2025

(54) MODULAR ELECTRONIC DATA RECORDER (EDR) CONFIGURATIONS FOR AUTONOMOUS VEHICLES

(71) Applicant: Torc Robotics, Inc., Blacksburg, VA (US)

(72) Inventors: Akshay Pai Raikar, Blacksburg, VA (US); Joseph R. Fox-Rabinovitz, Blacksburg, VA (US); William Davis, Blacksburg, VA (US); Armenio Rivero, Blacksburg, VA (US)

(21) Appl. No.: 18/410,104

(22) Filed: Jan. 11, 2024

(51) Int. Cl. G07C 5/00

(52) U.S. Cl. CPC G07C 5/008

(57) ABSTRACT

In one aspect, a vehicle and associated method includes multiple electronic data recorders (EDRs) that includes a modular EDR and a replacement EDR configured to replace the modular EDR; a memory storing instructions, and at least one processor in communication with the plurality of EDRs and the memory, where the at least one processor is configured to execute the instructions to coordinate at least part of a transfer of data between the plurality of EDRs, and at least part of a replacement operation that includes exchanging the modular EDR for the replacement EDR.

### TECHNICAL FIELD

The field of the disclosure relates generally to autonomous and semi-autonomous vehicles, and more particularly, to a system and associated method of safeguarding event data.

### BACKGROUND

An electronic data recorder (EDR) is conventionally a device installed in a motor vehicle to record technical vehicle and occupant information for a period before, during, and after a crash. The data is preserved generally for the purpose of monitoring and assessing vehicle safety system performance. The recorded data may additionally have legal and insurance implications, as well as be used to improve the safety of future travel.

By their nature, EDRs collect large amounts of data that is used for measuring and improving the system, as well as to provide context during system triage. EDRs collect raw sensor data, including internal vehicle sensors, as well as the intermediate computations of autonomy system components. EDRs may additionally debug data, as well as perform other functions that might facilitate reconstructing a scenario from the point of view of the vehicle carrying the EDR. Examples of the sensor data includes video, radio detection and ranging (RADAR), and light detection and ranging (LiDAR) data streams, among others. Examples of processed data include records of planned and executed behaviors, map correlations, and motion state estimates of the vehicle. The large amounts of high-definition data pose a challenge to the limited capacity onboard storage that is conventionally available on autonomous vehicles.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a vehicle includes multiple electronic data recorders (EDRs) where the multiple EDRs include a modular EDR and a replacement EDR configured to replace the modular EDR; a memory storing instructions, and at least one processor in communication with the plurality of EDRs and the memory, where the at least one processor is configured to execute the instructions to coordinate at least part of a transfer of data between the plurality of EDRs, and at least part of a replacement operation that includes exchanging the modular EDR for the replacement EDR

In another aspect, a method of managing EDR data includes coordinating at least part of a transfer of data between a plurality of EDRs, where the plurality of EDRs includes a modular EDR and a replacement EDR configured to replace the modular EDR and initiating at least part of a replacement operation that includes exchanging the modular EDR for the replacement EDR.

In another aspect, an implementation includes at least one non-transitory computer-readable storage medium with instructions stored thereon that, in response to execution by at least one processor, cause the at least one processor to coordinate at least part of a transfer of data between a plurality of EDRs, where the plurality of EDRs includes a modular EDR and a replacement EDR configured to replace the modular EDR, and initiate at least part of a replacement operation that includes exchanging the modular EDR for the replacement EDR.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 illustrates a vehicle that may include a truck that may further be conventionally connected to a single or tandem trailer to transport the trailers (not shown) to a desired location.

FIG. 2 is an exemplary schematic block diagram of a processing system for implementation of embodiments of the present disclosure.

FIG. 3 is a block diagram of an autonomous driving system, including an autonomous vehicle that is communicatively coupled with a mission control computing system.

FIG. 4 is a block diagram showing illustrative components of an EDR system juxtaposed with an outline of an autonomous or semi-autonomous vehicle.

FIG. 5 depicts a sequence of the coordinated storage of EDR data between a fixed EDR and a swappable, modular at different points in time.

FIG. 6 depicts a sequence of the coordinated storage of EDR data between a modular EDR and another modular EDR at different points in time.

FIG. 7 is a flow diagram of an embodiment of a method of coordinating the storage of EDR data between a fixed, stationary EDR and multiple, interchangeable, modular EDRs.

FIG. 8 is a flow diagram of an embodiment of a method of coordinating the storage of EDR data between multiple, interchangeable, modular EDRs.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

An embodiment described in this disclosure attempts to address EDR storage issues by using a redundant, modular, and swappable electronic data recording (EDR) system. The system may coordinate EDR data storage operations between two or more EDRs. Because local on-board storage is limited and data rates are large, successful retention of data often includes frequent data offloading to make space for new data. As such, an autonomous truck may have access to a data download and upload facility at a trucking hub. The uploading may introduce operational latency leading to business inefficiency. Compounding slow upload operations, technicians at the hubs may not always perform the operations or may do so incorrectly.

An embodiment described in this disclosure addresses these complications by using an interchangeable (e.g., swappable, or modular) EDR system. In one implementation, an EDR system may include a set of two EDRs, or loggers. One of the loggers may be fixed and the other may be detachable, or swappable. The EDR may comprise a circular buffer and the primary, fixed (e.g., static) logger may comprise a black box backup. As such, the fixed EDR may record and store data until it is full and then will transfer the initial unit of data into the swappable, secondary logger. The transfer in one example may be as a First in, First out (FIFO) manner. Once the secondary logger is full or approaches fullness, the user may be notified and prompted to pull out the logger and set it up to upload to remote storage. The fixed logger may be positioned and secured within the truck with extra packaging and other protection to make sure it is available for accident triage and deconstruction.

In another implementation, two swappable, or modular, loggers may be used. One of the EDR loggers may function initially as a primary logger with the other EDR functioning as a secondary EDR. The EDRs may be swapped one at a time to maintain continuous buffer space. In addition, the EDR system may include a latch that unlatches when the loggers are full, or an LED to indicate which one to swap. Other implementations may include a digital display showing an extent of storage capacity that has been utilized (and remains available).

Where so configured, the truck may be forced to remain in a standby state (e.g., unable to move or open a fuel latch) until the server station sends a message stating the data upload has started or is complete, or a sufficiently empty EDR is inserted into the correct slot. An embodiment of a server station may include a hub where data uploads are performed. This feature may minimize instances of a pile-up of data loggers at upload station interfaces, while ensuring that data is routinely uploaded in a timely manner.

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, or steering wheel positioning, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA. The semi-autonomous vehicle requires a human driver at all times for operating the semi-autonomous vehicle.

A non-autonomous vehicle: A non-autonomous vehicle is a vehicle that is driven by a human driver. A non-autonomous vehicle is neither an autonomous vehicle nor a semi-autonomous vehicle. A non-autonomous vehicle has an autonomy level of level-0 recognized by NHTSA.

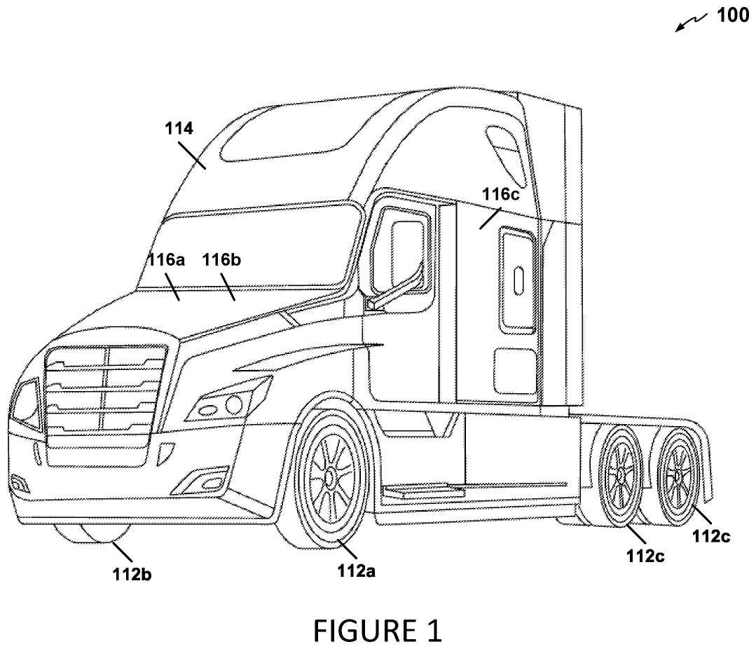

FIG. 1 illustrates a vehicle 100 that may include a truck that may further be conventionally connected to a single or tandem trailer to transport the trailers (not shown) to a desired location. The vehicle 100 includes a cab 114 that can be supported by, and steered in, the required direction by front wheels 112a, 112b, and rear wheels 112c that are partially shown in FIG. 1. Wheels 112a, 112b are positioned by a steering system that includes a steering wheel and a steering column (not shown in FIG. 1). The steering wheel and the steering column may be located in the interior of cab 114. The steering wheel, the steering column, and any other parts of the cab may be omitted in an autonomous vehicle. Modular EDRs 116a-c may record technical vehicle information, as explained herein. The recording may occur continuously, periodically, or in response to an event. The orientation and positioning of the EDRs 116a-c in FIG. 1 is arbitrary, and it should be understood they may be positioned at any suitable location in the vehicle 100. For instance, EDRs may be collocated for ease of maintenance.

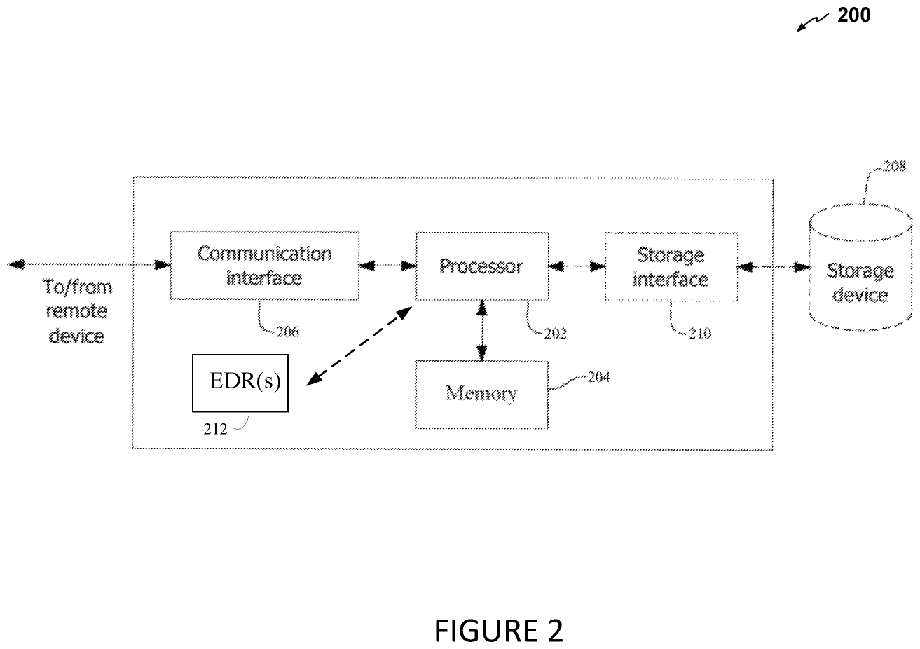

FIG. 2 is an exemplary schematic block diagram of a processing system 200 for implementation of embodiments of the present disclosure. The processing system 200 may include the automated tire monitoring and defect detection system described herein. The processing system 200 may include one or more processing units or processors 202 (e.g., in a multi-core configuration). Processor 202 may be operatively coupled to a communication interface 206 such that the processing system 200 is capable of communicating with another device, such as a remote application server, a user equipment, a mobile device, a smart vehicle, a mission control or a central hub, or another processing system, for example, using wireless communication or data transmission over one or more radio links or digital communication channels using one or more of a Wi-Fi protocol, an RFID protocol, or a Near-Field Communication (NFC) protocol, as one-way communication or two-way communication.

Processor 202 may also be operatively coupled to a storage device 208. Storage device 208 may be any computer-operated hardware suitable for storing or retrieving data, such as, but not limited to, data associated with historic databases. In some embodiments, storage device 208 may be integrated in the processing system 200. For example, the processing system 200 may include one or more hard disk drives as storage device 208.

In other embodiments, storage device 208 may be external to the processing system 200 and may be accessed by a using a storage interface 210. For example, storage device 208 may include a storage area network (SAN), a network attached storage (NAS) system, or multiple storage units such as hard disks or solid-state disks in a redundant array of inexpensive disks (RAID) configuration.

In some embodiments, processor 202 may be operatively coupled to storage device 208 via the storage interface 210. Storage interface 210 may be any component capable of providing processor 202 with access to storage device 208. Storage interface 210 may include, for example, an Advanced Technology Attachment (ATA) adapter, a Serial ATA (SATA) adapter, a Small Computer System Interface (SCSI) adapter, a RAID controller, a SAN adapter, a network adapter, or any component providing processor 202 with access to storage device 208.

The processor 202 may execute computer-executable instructions for implementing aspects of the disclosure. In some embodiments, the processor 202 may be transformed into a special purpose microprocessor by executing computer-executable instructions or by otherwise being programmed. In some embodiments, and by way of a non-limiting example, the memory 204 may include instructions to perform specific operations, as described herein.

In certain implementations, the processor 202 may be in communication with one or more EDRs 212. In such a configuration, the processor 202 may coordinate data storage and swapping operations as between the EDRs 212, as described herein. For instance, the processor 202 may sense a crash is imminent and deploy the foam system. In other implementations, the EDRs 212 are self-contained and have sensing and activation circuitry and processors included within or proximate an EDR housing, or chamber.

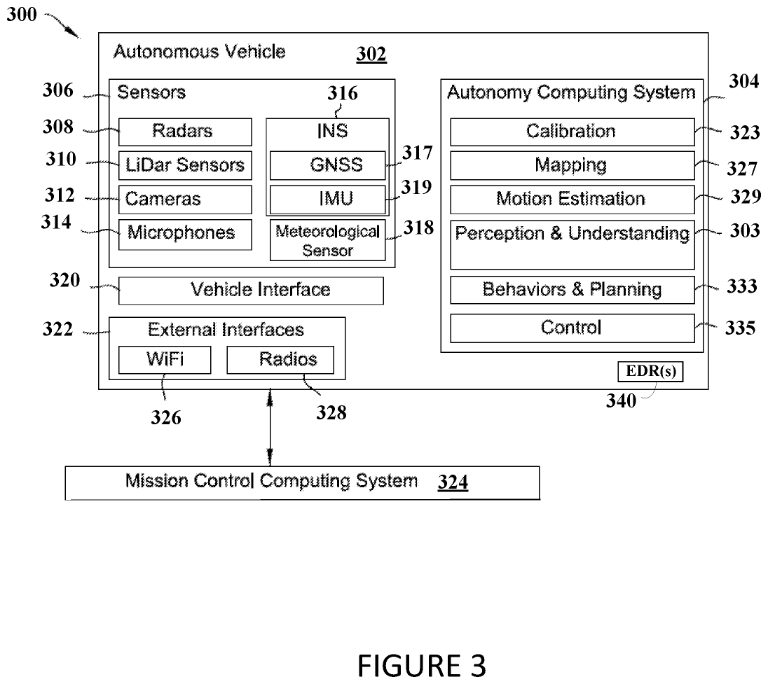

FIG. 3 is a block diagram of an autonomous driving system 300, including an autonomous vehicle 302 that is communicatively coupled with a mission control computing system 324. The vehicle 302 may be similar or the same as described with reference to any of the preceding figures.

In some embodiments, the mission control computing system 324 may transmit control commands or data to the autonomous vehicle 100, navigation commands, and travel trajectories to the autonomous vehicle 100, and may receive telematics data from the autonomous vehicle 302.

In some embodiments, the autonomous vehicle 100 may further include sensors 306. Sensors 306 may include radar detection and ranging (RADAR) devices 308, light detection and ranging (LiDAR) sensors 310, cameras 312, and acoustic sensors 314. The sensors 306 may further include an inertial navigation system (INS) 316 configured to determine states such as the location, orientation, and velocity of the autonomous vehicle 100. The INS 316 may include at least one global navigation satellite system (GNSS) receiver 317 configured to provide positioning, navigation, and timing using satellites. The INS 316 may also include at least one inertial measurement unit (IMU) 319 configured to measure motion properties such as the angular velocity, linear acceleration, or orientation of the autonomous vehicle 100. The sensors 306 may further include meteorological sensors 318. Meteorological sensors 318 may include a temperature sensor, a humidity sensor, an anemometer, pitot tubes, a barometer, a precipitation sensor, or a combination thereof. The meteorological sensors 318 are used to acquire meteorological data, such as the humidity, atmospheric pressure, wind, or precipitation, of the ambient environment of autonomous vehicle 302.

The autonomous vehicle 302 may further include a vehicle interface 320, which interfaces with an engine control unit (ECU) (not shown) or a MCU (not shown) of the autonomous vehicle 302 to control the operation of the autonomous vehicle 302 such as acceleration and steering.

The autonomous vehicle 302 may further include external interfaces 322 configured to communicate with external devices or systems such as another vehicle or mission control computing system 324. The external interfaces 322 may include Wi-Fi 326, other radios 328 such as Bluetooth, or other suitable wired or wireless transceivers such as cellular communication devices. Data detected by the sensors 306 may be transmitted to mission control computing system 324 via any of the external interfaces 322.

The autonomous vehicle 302 may further include an autonomy computing system 304. The autonomy computing system 304 may control driving of the autonomous vehicle 302 through the vehicle interface 320. The autonomy computing system 304 may operate the autonomous vehicle 302 to drive the autonomous vehicle from one location to another.

In some embodiments, the autonomy computing system 304 may include modules for performing various functions. Modules may include a calibration module 325, a mapping module 327, a motion estimation module 329, perception and understanding module 303, behaviors and planning module 333, and a control module 335. Modules and submodules may be implemented in dedicated hardware such as, for example, an application specific integrated circuit (ASIC), field programmable gate array (FPGA), or microprocessor, or implemented as executable software modules, or firmware, written to memory and executed on one or more processors onboard the autonomous vehicle 302.

In some embodiments, based on the data collected from the sensors 306, the autonomy computing system 304 and, more specifically, perception and understanding module 303 senses the environment surrounding the autonomous vehicle 302 by gathering and interpreting sensor data. A perception and understanding module 303 interprets the sensed environment by identifying and classifying objects or groups of objects in the environment. For example, perception and understanding module 303 in combination with various sensors 306 (e.g., LiDAR, camera, radar, etc.) of the autonomous vehicle 100 may identify one or more objects (e.g., pedestrians, vehicles, debris, etc.) and features of a roadway (e.g., lane lines) around autonomous vehicle 302, and classify the objects in the road distinctly.

In some embodiments, a method of controlling an autonomous vehicle, such as autonomous vehicle 302, includes collecting perception data representing a perceived environment of autonomous vehicle 302 using the perception and understanding module 303, comparing the perception data collected with digital map data, and modifying operation of the vehicle 302 based on an amount of difference between the perception data and the digital map data. Perception data may include sensor data from sensors 306, such as cameras 312, LiDAR sensors 310, RADAR 308, or from other components such as motion estimation 329 and mapping 327.

The mapping module 327 receives perception data or raw sensor data that can be compared to one or more digital maps stored in mapping module 327 to determine where the autonomous vehicle 302 is in the world or where autonomous vehicle 302 is on the digital map(s). In particular, the mapping module 327 may receive perception data from perception and understanding module 303 or from the various sensors sensing the environment surrounding autonomous vehicle 302 and may correlate features of the sensed environment with details (e.g., digital representations of the features of the sensed environment) on the one or more digital maps. The digital map may have various levels of detail and can be, for example, a raster map, or a vector map. The digital maps may be stored locally on the autonomous vehicle 302 or stored and accessed remotely. In at least one embodiment, the autonomous vehicle 302 deploys with sufficient stored information in one or more digital map files to complete a mission without connection to an external network during the mission.

The behaviors and planning module 333 and the control module 335 plan and implement one or more behavior-based trajectories to operate the autonomous vehicle 302 similarly to a human driver-based operation. The behaviors and planning module 333 and control module 335 use inputs from the perception and understanding module 303 or mapping module 327 and motion estimation 329 to generate trajectories or other planned behaviors. For example, behavior and planning module 333 may generate potential trajectories or actions and select one or more of the trajectories to follow or enact by the controller 335 as the vehicle travels along the road. The trajectories may be generated based on proper (i.e., legal, customary, and safe) interaction with other static and dynamic objects in the environment. Behaviors and planning module 333 may generate local objectives (e.g., following rules or restrictions) such as, for example, lane changes, stopping at stop signs, etc. Additionally, behavior and planning module 333 may be communicatively coupled to, include, or otherwise interact with motion planners, which may generate paths or actions to achieve local objectives. Local objectives may include, for example, reaching a goal location while avoiding obstacle collisions.

Based on the data collected from the sensors 306, the autonomy computing system 304 is configured to perform calibration, analysis, and planning, and control the operation and performance of autonomous vehicle 302. For example, the autonomy computing system 304 is configured to estimate the motion of autonomous vehicle 302, calibrate parameters of the sensors, such as the extrinsic rotations of cameras, LIDAR, RADAR, and IMU, as well as intrinsic parameters, such as lens distortions, in real-time, and provide a map of surroundings of autonomous vehicle 302 or the travel routes of autonomous vehicle 302. The autonomy computing system 304 is configured to analyze the behaviors of autonomous vehicle 302 and generate and adjust the trajectory plans for the autonomous vehicle 302 based on the behaviors computed by the behaviors and planning module 333.

In certain implementations, the autonomy computing system 304 may be in communications with one or more modular EDRs 340. In such a configuration, the autonomy computing system 304 may coordinate data storage uploads and EDR swapping, as described herein.

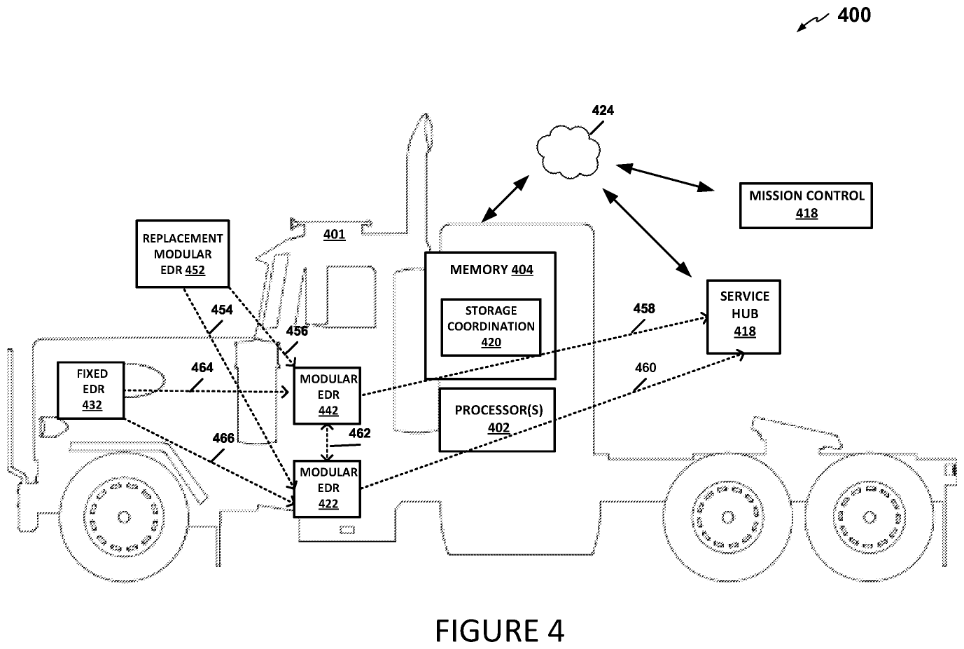

FIG. 4 is a block diagram showing illustrative components of an EDR system 400 juxtaposed with an outline of an autonomous or semi-autonomous vehicle 401. The relative positioning of the modules with respect to the outline are not intended to indicate a physical location, as the underlying hardware, software, and functionality of the modules may be dispersed throughout the vehicle and remotely throughout the system 400. For example, the system 400 includes one or more processors 402 in communication with a memory 404. While the processors 402 and memory 404 are depicted as being included within the autonomous truck, the processors and memory of another implementation, as well as their related functions may be distributed throughout one or more local and remote systems. For instance, a mission control center 418 may communicate instructions and data via a wireless connection 424. In another example, the one or more processors may include circuitry present in EDRs 422, 432, 442, and 452.

A memory 404 includes instructions (i.e., modules, or algorithms) executable by the processor 402 to operate the autonomous vehicle 401. For example, the memory 404 includes program code 420 for coordinating the storage of EDR data as between EDRs 422, 432, 442, as well as the uploading of the data onto the server (e.g., at a hub). As illustrated in FIG. 4, the system 400 includes multiple EDRs 422, 432, 442. More particularly, EDRs 422, 442 may be modular, or swappable EDRs, while EDR 432 may be permanently affixed. An implementation of the system 400 may enable the fixed EDR 432 to coordinate data storage with one or more of the modular, or detachable EDRs 422, 442 (as represented by dashed lines 464 and 466). The fixed EDR 432 may record and store data until it is full and then transfer the initial unit of data into the swappable, secondary EDR 422, 442 in a FIFO manner. Once the secondary EDR 422, 442 is full, close to full, the user may be notified and prompted to pull out the EDR 422, 442 and set it up to upload onto company servers (as represented by dashed lines 458 and 460). The fixed EDR 432 may be positioned and secured within the truck with extra packaging and other protection to make sure it is available for accident triage and deconstruction.

In another implementation, the swappable, or modular EDR 422, 442 may be used without a fixed EDR 432. As such, one of the EDRs 422 may function initially as a primary logger with the other EDR 442 functioning as a secondary EDR. The EDRs 422, 442 may be swapped one at a time to maintain continuous buffer space. The dashed line 462 designates the two-way communication between the EDRs 422, 442. A swappable, replacement modular EDR 452 is shown ready to replace either of the modular EDRs 442, 444 (as represented by dashed lines 454 and 456) when they become full or are otherwise ready for uploading to the server.

With either implementation, the modular EDRs 422, 442 may include selectively actuated securing mechanism, such as a latch that unlatches when the loggers are full. Another or the same implementation may include an electronically changeable display, such as an LED display or a device display screen to indicate the EDR to swap as well as other useful information, such as the total and available capacities of an EDR. This feature may facilitate prompt and accurate uploading, swapping, and other maintenance. Where so configured, the truck may be forced to remain in a standby state (e.g., unable to move or open a fuel latch) until the server station sends a message stating the data upload has started or is complete. This feature may minimize instances of a pile-up of data loggers at upload station interfaces, while ensuring that data is routinely uploaded in a timely manner.

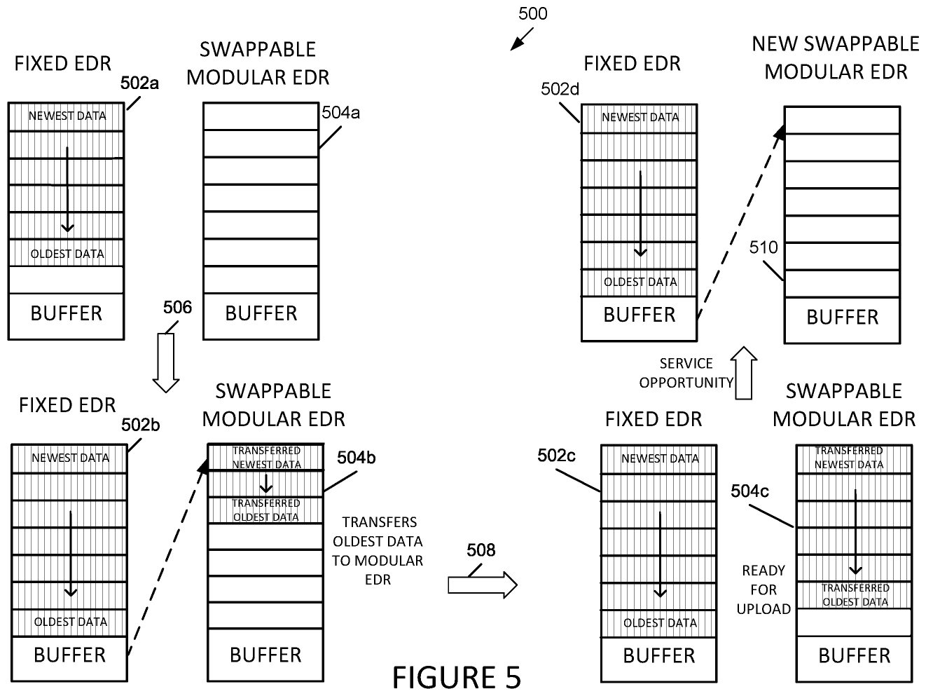

FIG. 5 depicts a sequence of coordinated operations of the EDRs 502, 504, 510 at different points in time. More particularly, the system 500 shows the coordinated storage of EDR data between a fixed EDR 502a and a swappable, modular EDR 504a at first point in time, such as near the beginning of a trip. As shown in the FIG. 5, the newest EDR data is stored near the top of the fixed EDR 502a, which pushes the earlier received data farther from the top of the fixed EDR. In some embodiments, EDR storage is implemented in the manner of a ring buffer. During continued use, the fixed EDR 502a may be receives and stores EDR data (e.g., raw and processed sensor data, as well as communications with the tractor). Over time the stored data may near the capacity of the fixed EDR 502a.

After some time (the passage of which is represented by the arrow 506), fixed EDR 502a becomes full and transfers the stored data that has been in the fixed EDR 502a for the longest period of time to the modular EDR 504b. The data may be transferred in a FIFO manner. As the data that has been stored for the longest period of time is transferred, the fixed EDR 502b may continue to receive the newest EDR data. As such, the fixed EDR 502b may maintain a log of the most recent EDR data while its earlier received data is sent to the modular EDR 504b.

At a later time (designated by arrow 508), the swappable, modular EDR 504c may be nearing its storage capacity. In another scenario, the truck carrying the EDRs 502c, 504c may be arriving at a hub where a server upload is convenient. In either case, the modular EDR 504c may be detached and replaced with a new modular EDR 510 having full storage capacity. The data from the detached EDR 504c may be uploaded to the server without the truck having to wait for the uploading process to complete. Once on the road, again, the fixed EDR 502d may resume transferring earlier received EDR data to the new modular EDR 510, as indicated by the dashed line.

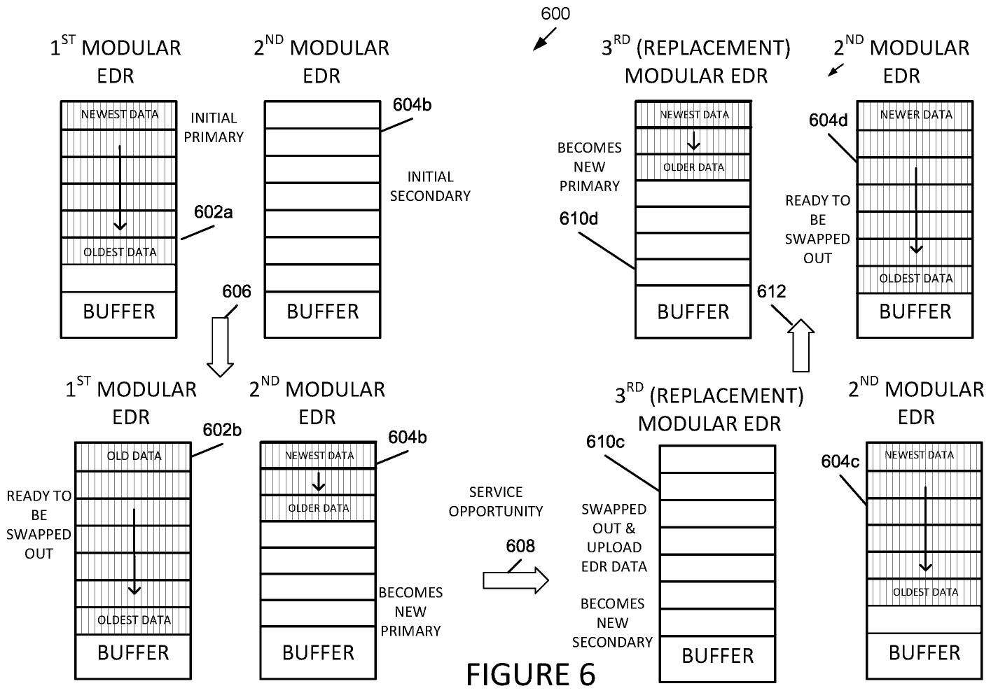

FIG. 6 depicts a sequence of coordinated operations of three modular EDRs 602, 604, 610 at different points in time. More particularly, the system 600 shows the coordinated storage of EDR data between a modular EDR 602a and another modular EDR 604a at a first point in time, such as near the beginning of a trip. As shown in FIG. 6, the most recently receive EDR data is stored near the top of the modular EDR 602a, which pushes the earlier received data downward. At this stage, the modular EDR 602a may function as a primary, device for storing the EDR data. During continued use, the stored data may near the capacity of the modular EDR 602a.

After some time (the passage of which is represented by the arrow 606), the modular EDR 602b becomes full and EDR 604b begins to function as the primary EDR. In this embodiment, rather than transferring data between EDRs, EDR data is always recorded on the primary EDR. As such, the primary EDR 604b may maintain a log of the most recent EDR data while its earlier received data remains on the modular EDR 602b.

At a later time (designated by arrow 608), the swappable, modular EDR 604c which is now functioning as the primary EDR may be nearing it storage capacity. In another scenario, the truck carrying the EDRs 602b, 604b may be arriving at a hub where a server upload is convenient. In either case, the modular EDR 602b may be detached and replaced with a new modular EDR 610c having a full storage capacity. The data from the detached EDR 602b may be uploaded to the server without the truck having to wait for the uploading process to complete. The modular EDR 604d may remain the new primary EDR and receive the new data communicated to the EDR. Once EDR 604d becomes full, modular EDR 610d may become the primary, as detailed above.

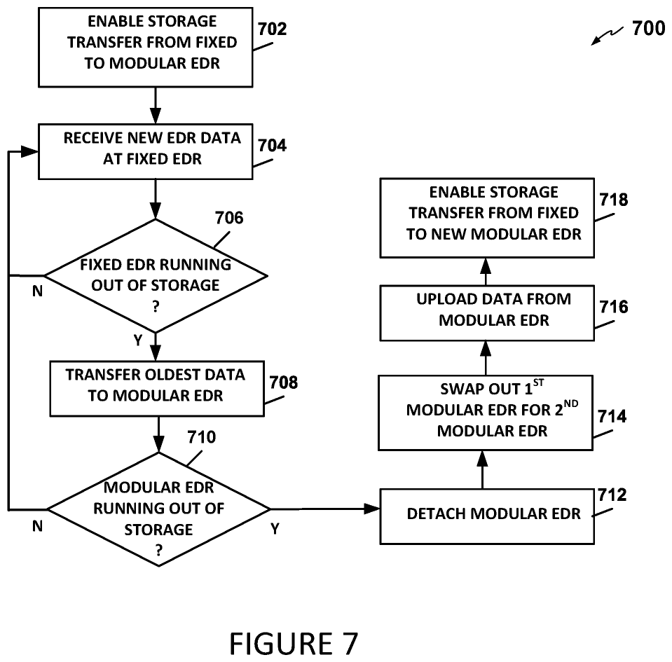

FIG. 7 is a flow diagram of an embodiment of a method 700 of coordinating the storage of EDR data between a fixed, stationary EDR and multiple, interchangeable, modular EDRs. While many of the illustrative processes described herein may apply to a semi-truck and trailer, the embodiments of the underlying method 700 may apply to other types of autonomously driving vehicles. Moreover, the processes described in the flow diagram may be performed in different sequences in different embodiments of the method 700, which may omit or add other processes from that which is shown in the example of FIG. 7. The method 700 may be performed by any of the systems described in FIGS. 1-4.

Turning more particularly to FIG. 7, the method 700 includes at 702 enabling the storage transfer from a fixed EDR and a swappable, modular EDR. For example, the method may enable the storage transfer from the fixed EDR 502a of FIG. 5 and the swappable, modular EDR 504a. At 704, the fixed EDR 502a may be receiving and storing EDR data.

As the storage in the fixed EDR approaches storage capacity at 706, the EDR may transfer at 708 its earliest received data to the modular EDR. The data may be transferred in a FIFO manner, and the fixed EDR may continue to receive the most recently received EDR data. As such, the fixed EDR may maintain a log of the most recently received data while its earliest received data is sent to the modular.

At 710, the swappable, modular may be nearing its storage capacity. In another scenario, the vehicle carrying the EDRs may be arriving at a hub where a server upload is convenient. In either case, the modular EDR may be detached at 712 and replaced at 714 with a new modular EDR having full storage capacity. The data from the detached EDR may be uploaded at 716 to the server without the truck having to wait for the uploading process to complete. Once the vehicle has returned to the road, the fixed EDR may resume at 718 transferring earlier received EDR data to the new modular EDR.

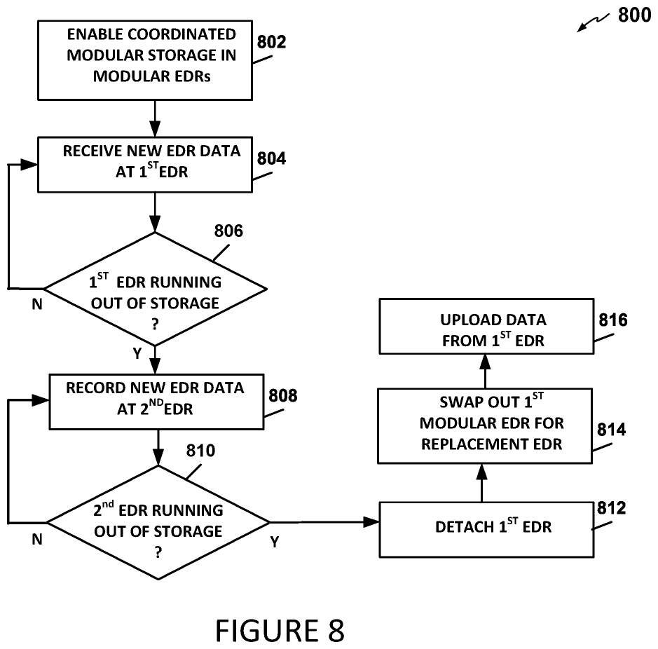

FIG. 8 is a flow diagram of an embodiment of a method 800 of coordinating the storage of EDR data between multiple, interchangeable, modular EDRs. While many of the illustrative processes described herein may apply to a semi-truck and trailer, the embodiments of the underlying method 800 may apply to other types of autonomous vehicles. Moreover, the processes described in the flow diagram may be performed in different sequences in different embodiments of the method 800, which may omit or add other processes from that which is shown in the example of FIG. 8. The method 800 may be performed by any of the systems described in FIGS. 1-4.

Turning more particularly to the drawing, the method 800 may include enabling at 802 coordinated operations of between at least two modular EDRs, such as the EDRs 602, 604 of FIG. 6. At 804, the recently received EDR data may be at a first EDR designated as a primary. At 806, the stored data may become full or near its storage capacity, the modular EDR may at 808 begin to transfer its earliest received data to the secondary modular EDR.

At 810, the secondary EDR may be nearing it storage capacity. In another scenario, the truck carrying the EDRs may be arriving at a hub where a server upload is convenient. In either case, the the first modular EDR may be detached at 812 and replaced at 814 with a new modular EDR having fresh storage capacity. The data from the detached EDR may be uploaded at 816 to the server without the truck having to wait for the uploading process to complete. The modular EDR that was not removed may become the new primary and receive the currently communicated EDR data.

The client device as described herein may include a user equipment, a mobile device, a tablet, a smartwatch, a laptop, a smart glass, an internet-of-things (IOT) device, or a smart vehicle. The vehicle may be an autonomous vehicle, a semi-autonomous vehicle, or a non-autonomous vehicle.

Some embodiments involve the use of one or more electronic processing or processing systems. As used herein, the terms “processor” and “computer” and related terms, e.g., “processing device,” “processing system,” and “controller” are not limited to just those integrated circuits referred to in the art as a computer, but broadly refers to a processors, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms such as processor, processing device, and related terms.

In the embodiments described herein, memory may include, but is not limited to, a non-transitory computer-readable medium, such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A vehicle comprising:
a plurality of electronic data recorders (EDRs) that includes a modular EDR and a replacement EDR configured to replace the modular EDR;
a memory storing instructions;
at least one processor in communication with the plurality of EDRs and the memory, wherein the at least one processor is configured to execute the instructions to coordinate:
at least part of a transfer of data between the plurality of EDRs; and
at least part of a replacement operation that includes exchanging the modular EDR for the replacement EDR.

2. The vehicle of claim 1, wherein the at least one processor is further configured to determine that the modular EDR is running low on storage space.

3. The vehicle of claim 1, wherein EDR data stored on the modular EDR is uploaded to a server after the replacement operation.

4. The vehicle of claim 1, wherein the plurality of EDRs includes a permanently affixed EDR.

5. The vehicle of claim 4, wherein the at least one processor is further configured to determine that the permanently affixed EDR is running low on storage space.

6. The vehicle of claim 4, wherein EDR data stored in the permanently affixed EDR is transferred to the modular EDR.

7. The vehicle of claim 4, wherein EDR data stored in the permanently affixed EDR is transferred to the replacement EDR after the replacement operation.

8. The vehicle of claim 7, wherein the EDR data is the oldest EDR data stored in the permanently affixed EDR.

9. The vehicle of claim 7, wherein the EDR data is transferred according to First In, First Out (FIFO) processes.

10. The vehicle of claim 1, further comprising another modular EDR of the plurality of EDRs.

11. The vehicle of claim 10, wherein the at least one processor is further configured to determine that the other modular EDR is running low on storage space, and in response, to transfer EDR data from the other modular EDR to the modular EDR in a First in, First out (FIFO) manner.

12. The vehicle of claim 1, wherein the at least one processor is further configured to disable movement of the vehicle until the replacement operation is complete.

13. The vehicle of claim 1, further comprising a releasable securing mechanism to prevent erroneous removal of another EDR of the plurality of EDRs during the replacement operation.

14. The vehicle of claim 1, further comprising an electronically changeable display indicating which of the plurality of EDRs should be replaced during the replacement operation.

15. A method of managing electronic data recorder (EDR) data, the method comprising:
coordinating at least part of a transfer of data between a plurality of EDRs, wherein the plurality of EDRs includes a modular EDR and a replacement EDR configured to replace the modular EDR; and
initiating at least part of a replacement operation that includes exchanging the modular EDR for the replacement EDR.

16. The method of claim 15, further comprising inhibiting a vehicle from driving away from a server hub until the replacement operation is complete.

17. The method of claim 15, further comprising determining that the modular EDR is running low on storage space.

18. The method of claim 15, further comprising uploading EDR data stored on the modular EDR to a server after the replacement operation.

19. The method of claim 15, wherein the plurality of EDRs includes a permanently affixed EDR.

20. At least one non-transitory computer-readable storage medium with instructions stored thereon that, in response to execution by at least one processor, cause the at least one processor to:
coordinate at least part of a transfer of data between a plurality of EDRs, wherein the plurality of EDRs includes a modular EDR and a replacement EDR configured to replace the modular EDR; and
initiate at least part of a replacement operation that includes exchanging the modular EDR for the replacement EDR.
